(19) United States
(12) Patent Application Publication
(10) Pub. No.: US 2017/0362765 A1
(43) Pub. Date: Dec. 21, 2017

(54) WALL-MOUNTED WASHING MACHINE AND INSTALLATION METHOD THEREOF

(71) Applicant: Dongbu Daewoo Electronics Corporation, Seoul (KR)

(72) Inventor: Jong Jin LEE, Seoul (KR)

(21) Appl. No.: 15/288,786

(22) Filed: Oct. 7, 2016

(30) Foreign Application Priority Data
Jun. 20, 2016 (KR) 10-2016-0076773

(51) Int. Cl. D06F 39/12; F16B 5/02

(52) U.S. Cl. CPC D06F 39/125; F16B 5/0241

(57) ABSTRACT

A fastener kit for mounting a washing machine to a wall having a block cavity. The washing machine includes a rear panel at the rear end of the housing. The fastener kit can affix the rear panel to an external wall. When the washing machine is mounted on the wall, a first end of the fastener kit is positioned inside a block cavity of the external wall through a fastening hole formed on the external wall. The second end of the fastener kit is coupled to the real panel. The fastener kit can support the washing machine on the wall against gravity through contact between the first end and an inner surface of the block cavity.

### CROSS-REFERENCE TO RELATED APPLICATION

This application is based on and claims priority from Korean Patent Application No. 10-2016-0076773, filed on Jun. 20, 2016, the disclosure of which is incorporated herein in its entirety by reference for all purposes.

### TECHNICAL FIELD

The present disclosure relates to wall-mounted washing machines and installation methods thereof, and more particularly, to wall-mounted washing machines which can be securely mounted on a block wall and installation methods thereof.

### BACKGROUND OF THE INVENTION

A wall-mounted washing machine can be installed on a wall, which is particularly useful for rooms with relatively small spaces.

Generally, a wall-mounted drum type washing machine includes a cabinet, a tub disposed within the cabinet and configured to store washing water, a drum rotatably installed in the tub and configured to accommodate laundry or other washing objects, a drive device configured to supply power to drive rotation of the drum, a water supply device configured to supply washing water into the tub, and a drain device configured to drain washing water from the tub to outside of the cabinet.

Once a washing operation is started, washing water is supplied into the tub and the drum by the operation of the water supply device. The drum is rotated by the drive device. At the end of washing, washing water in the tub and the drum is drained to the outside of the cabinet by operation of the drain device.

A wall-mounted drum type washing machine usually is designed with a compact size. For example, it can be installed on a wall of a bathroom that typically has a small area.

However, generally, a block wall built with block bricks having cavities inside may not be able to support the weight of the washing machine if only ordinary bolts are used for installation.

In particular, due to vibration generated in the course of dewatering and rinsing the washing object, the affixture between the washing machine and the wall may become loose. In a worse scenario, the washing machine may even fall from the wall, causing damage to the washing machine as well as the wall, and even beyond.

### SUMMARY OF THE INVENTION

Embodiments of the present disclosure provide fastening mechanisms of securely mounting a wall-mounted washing machine to a wall.

In accordance with an aspect, a washing machine includes an housing; a rear panel coupled to the housing; and a fastener kit configured to affix the rear panel to a wall. When the washing machine is mounted on the wall, a first end of the fastener kit is positioned inside a block cavity of the wall through a fastening hole formed on the wall. The fastener kit is operable to support the washing machine against gravity on the wall through contact between the first end and an inner surface of the block cavity. A second end of the fastener kit is coupled to the rear panel.

The washing machine may further include a tub configured to contain washing water; and a drum rotatably installed in the tub and configured to contain laundry.

The tub may be integrally formed with the rear panel.

The fastener kit may include: a strap, a support piece, a fixing cap and an insertion unit. The strap is operable to be inserted through the fastening hole during a process of mounting the washing machine to an external surface of the wall. The support piece is rotatably coupled to one end of the strap and configured to press against the inner surface of the block cavity when the washing machine is mounted on the wall. The fixing cap is movable along a longitudinal direction of the strap so that the fixing cap is securely pressed against the wall. The insertion unit is configured to be inserted into the fastening hole so that the insertion unit is combined with the fixing cap and the support piece for securing the coupling between the fixing cap, the support piece and the wall.

The support piece may include a support hole at a center thereof. The fixing cap may include a fixing hole at a center thereof. The insertion unit may include an anchor rod for insertion through the fixing hole and the support hole and a fastening nut configured to secure the coupling between the rear panel to the anchor rod.

The insertion unit may be an anchor bolt inserted through the fixing hole and the support hole so as to fix the rear panel to the wall.

The strap may include: a holder portion forming a closed loop; support portions extending from opposite sides of the holder portion and having end portions rotatably coupled to the support piece; and ratchet portions formed on inner surfaces of the support portion.

The ratchet portions restrict the fixing cap to moving in one direction along the strap.

The fastener kit may further include a shock-absorbing member configured to attenuate vibration when it is disposed between an external surface of the wall and the rear panel.

In accordance with another aspect, a washing machine includes an housing; a rear panel coupled to the housing; a fastener kit configured to affix the washing machine through the rear panel to a wall; and a shock-absorbing member configured to be disposed between the wall and the rear panel to absorb vibration during operation of the washing machine.

when the washing machine is mounted on the wall; a first end of the fastener kit is positioned inside a block cavity of the wall through a fastening hole formed on the wall; the fastener kit is operable to support the washing machine against gravity on the wall through contact between the first end and an inner surface of the block cavity; and a second end of the fastener kit coupled to the rear panel.

The washing machine may further include: a tub configured to contain washing water; and a drum rotatably installed in the tub. The tub may be integrally formed with the rear panel.

The fastener kit may include: a strap, a support piece, a fixing cap and an insertion unit. The strap is operable to be inserted through the fastening hole during an installation process of mounting the washing machine to the wall. The support piece is rotatably coupled to one end of the strap and configured to press against the inner surface of the block cavity when the washing machine is mounted on the wall. The fixing cap is movable along a longitudinal direction of the strap so that the fixing cap is securely pressed against the wall. The insertion unit is configured to be inserted into the fastening hole so that the insertion unit is combined with the fixing cap and the support piece for securing the coupling between the fixing cap, the support piece and the wall.

The support piece may include a support hole at a center thereof. The fixing cap may include a fixing hole at a center thereof. The insertion unit may include: an anchor rod for being inserted through the fixing hole and the support hole; and a fastening nut configured to secure the coupling between the rear panel to the anchor rod.

The strap may include: a holder portion forming a closed loop; support portions extending from opposite sides of the holder portion and having end portions rotatably coupled to the support piece; and ratchet portions formed on the support portion and configured to restrict the fixing cap to moving in one direction along the strap.

In accordance with still another aspect, there is provided a method of installing a washing machine on a wall. A fastening hole is formed in the wall having a block cavity. The washing machine is coupled to the wall through a fastening kit including a strap, a support piece, a fixing cap and an insertion unit. In the coupling, the support piece that is coupled to the strap is inserted into the fastening hole and the support piece is placed in the block cavity. The fixing cap is moved along the strap and the support piece is affixed to an inner wall of the block cavity. The washing machine is affixed to the fixing cap and the support piece by using the insertion unit configured to be inserted into the fastening hole so that the insertion unit is combined with the fixing cap and the support piece for securing the coupling between the fixing cap, the support piece and the wall.

In affixing the support piece to the inner wall, the strap is adjusted to press the support piece against the inner wall of the block cavity. The fixing cap is moved toward one end of the strap. The fixing cap is pressed against an outer surface of the wall.

One end portion of the strap positioned at a rear side of the fixing cap may be removed.

The insertion unit may include an anchor rod and a fastening nut. In affixing the washing machine to the fixing cap and the support piece, the anchor rod is passed through a fixing hole of the fixing cap and a support hole of the support piece, and wherein a rear panel of the washing machine is fitted to the anchor rod and is secured by the fastening nut.

Upon the affixing the washing machine to the fixing cap and the support piece, the fixing cap and the support piece are positioned in parallel with each other.

According to embodiments of the present disclosure, a wall-mounted washing machine can be securely mounted on a block wall having a block cavity.

Furthermore, according to embodiments of the present disclosure, vibration generated in the course of dewatering and rinsing is restrained from being transferred to the block wall. Embodiments of the present disclosure can suppress noise generated by vibration and prevent the washing machine from being detached from the block wall due to failure of the fastening mechanism.

### BRIEF DESCRIPTION OF THE DRAWINGS

FIG. 1 illustrates an exemplary wall-mounted washing machine according to one embodiment of the present disclosure.

FIG. 2 illustrates a partial sectional view of the wall-mounted washing machine according to one embodiment of the present disclosure.

FIG. 3 illustrates an enlarged sectional view of a fastening region when the wall-mounted washing machine is mounted on a block wall according to one embodiment of the present disclosure.

FIG. 4 is an enlarged sectional view illustrating the fastening mechanism between a wall-mounted washing machine and a block wall according to another embodiment of the present disclosure.

FIG. 5 illustrates the fastening hole formed on the block wall in order to install the wall-mounted washing machine according to one embodiment of the present disclosure on the block wall.

FIG. 6 illustrates that the support piece of the fastener unit is inserted into the block cavity and that the fixing cap is pressed against the block wall.

FIG. 7 illustrates that one end of the strap is removed after the fastening unit is in place.

FIG. 8 is a flowchart illustrating an exemplary method of installing a wall-mounted washing machine according to one embodiment of the present disclosure.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described more fully hereinafter with reference to the accompanying drawings, in which one or more exemplary embodiments of the disclosure can be easily determined by those skilled in the art. As those skilled in the art will realize, the described exemplary embodiments may be modified in various different ways, all without departing from the spirit or scope of the present disclosure, which is not limited to the exemplary embodiments described herein.

It is noted that the drawings are schematic and are not necessarily dimensionally illustrated. Relative sizes and proportions of parts in the drawings may be exaggerated or reduced in their sizes, and a predetermined size is just exemplificative and not limitative. The same reference numerals designate the same structures, elements, or parts illustrated in two or more drawings in order to exhibit similar characteristics.

The exemplary drawings of the present disclosure illustrate ideal exemplary embodiments of the present disclosure in more detail. As a result, various modifications of the drawings are expected. Accordingly, the exemplary embodiments are not limited to a specific form of the illustrated region, and for example, include a modification of a form by manufacturing.

The configuration and operation according to one embodiment of the present disclosure will now be described in detail with reference to the accompanying drawings.

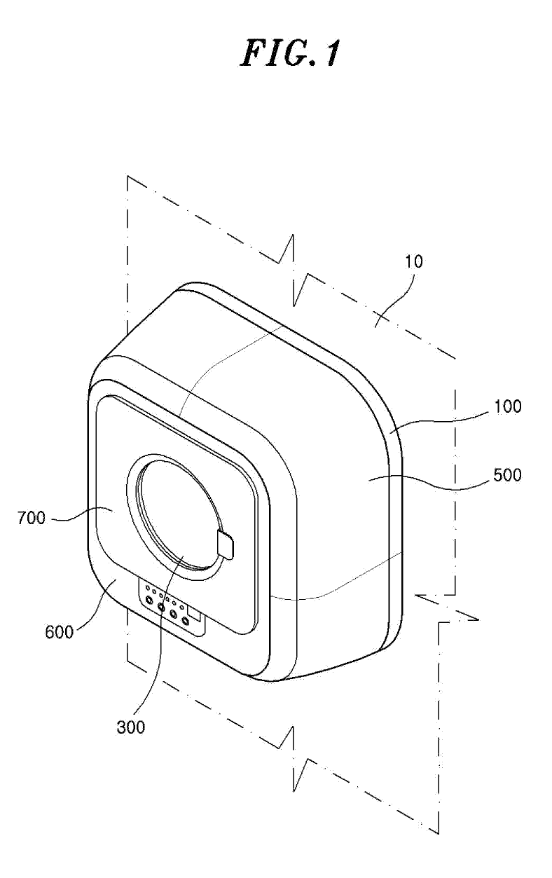

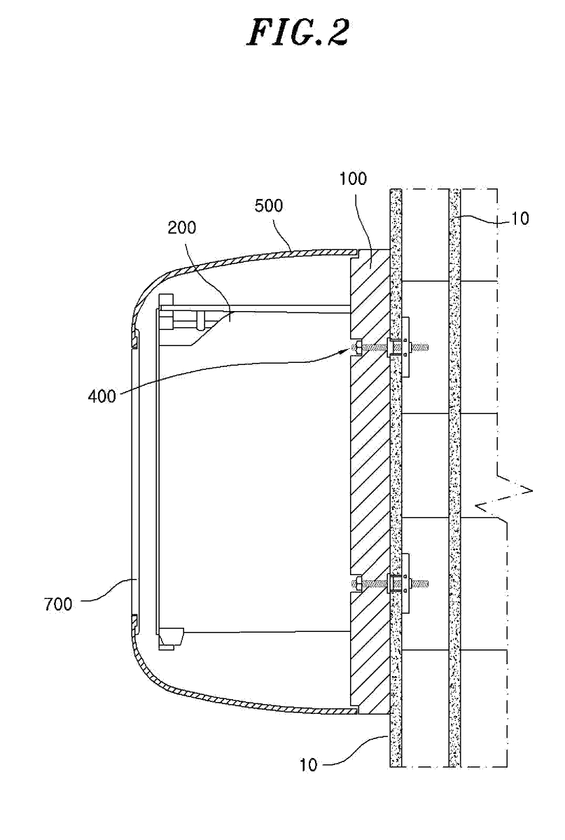

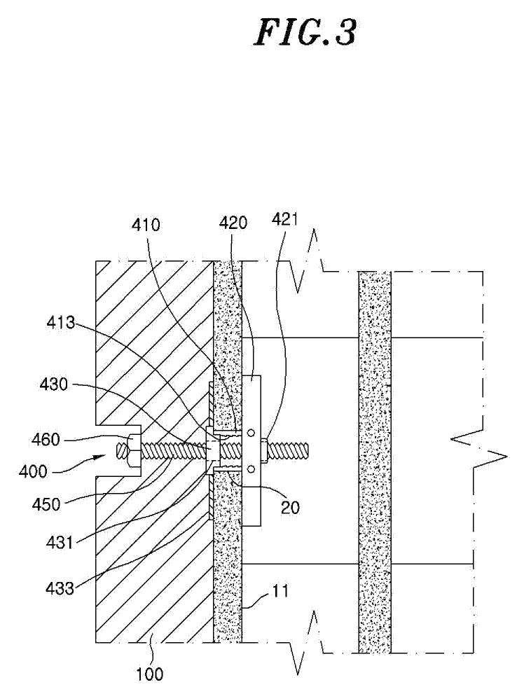

FIG. 1 illustrates an exemplary wall-mounted washing machine according to one embodiment of the present disclosure. FIG. 2 illustrates a partial sectional view of the wall-mounted washing machine according to one embodiment of the present disclosure. FIG. 3 illustrates an enlarged sectional view of a fastening region when the wall-mounted washing machine is mounted on a block wall according to one embodiment of the present disclosure.

Referring to FIGS. 1 to 3, the wall-mounted washing machine according to one embodiment of the present disclosure may include a rear panel 100, a tub 200, a drum 300, an housing 500, a cover 600, a front door 700 and a fastener unit 400 (or fastener kit). The washing machine may be securely installed on a block wall 10 having a block cavity 11. However, it will be appreciated that the present disclosure is not limited to drum type washing machines.

The rear panel 100 is a support frame which can be fixed to the block wall 10 through the fastener unit 400. The rear panel 100 may be a rectangular frame having round corners. The rear panel 100 may also be configured in any other suitable shape, such as a circular shape, an elliptical shape, etc.

The tub 200 may be integrally formed with the rear panel 100. Integral formation of the rear panel 100 with the tub 200 makes it unnecessary to use extra components for supporting the tub 200, such as a damper, a damping spring and the like. It can also reduce the number of components and the overall size of the washing machine. In particular, if the rear panel 100 is made of the same material as the tub 200, for example, a synthetic resin, the rear panel 100 and the tub 200 may be simultaneously formed by performing insert-injection at one time. Thus, the time and cost required in manufacturing the rear panel 100 and the tub 200 can be reduced.

The tub 200 is a cylindrical reservoir integrally formed with the rear panel 100 and used to store washing water. The tub 200 may receive washing water from a water supply device. Washing water may be drained from the tub 200 to the outside through a drain device. In this regard, the water supply device may include a water supply pipe providing a water supply path, and a water supply valve configured to control the flow rate of washing water supplied into the tub 200 through the water supply pipe. The drain device may include a drain pump configured to pump washing water for discharging, a drain pipe configured to provide a water drain path, and a drain port through which washing water is drained from the drain pipe.

The drum 300 may be rotatably mounted within the tub 200. The drum 300 is a cylindrical container configured to accommodate laundry and may be installed to rotate within the tub 200. For example, the drum 300 may receive drive power from a drive device and may make half or full rotation within the tub 200. The drive device may include a drive motor and a drive shaft rotatably coupled to the drive motor to deliver the drive power of the drive motor to the drum 300.

During a washing cycle, vibration generated due to drum rotation is usually small and can be mostly attenuated by the fastening force of the fastener unit 400 that fastens the rear panel 100 to a wall surface. However, vibration generated in the dewatering and rinsing cycles is more significant and may be hardly attenuated only by the fastening force of the fastener unit 400. Thus, a shock-absorbing member (433) for attenuating the vibration may be optionally disposed between the rear panel 100 and the block wall 10.

The housing 500 is coupled to the rear panel 100 and encloses the tub 200. The housing 500 may be formed in a cylindrical shape with a front opening and rear opening. The rear end of the housing 500 may be removably fixed to the rear panel 100 by fixing members such as screws or the like.

The cover 600 may be a circular panel and may be mounted to the open front portion of the housing 500. In the lower portion of the cover 600, there may be push buttons allowing a user to control the operation of the washing machine, a display window, and the like. An opening may be formed at the center of the cover 600. The front door 700 for covering the tub 200 covers the opening as well.

The fastener unit 400 may be fixed to the block wall 10 through a fastening hole 20 such that the washing machine can be affixed to the block wall 10. The fastener unit 400 may include a strap 410 that can be inserted into the fastening hole 20, a support piece 420 rotatably coupled to one end of the strap 410 and can be supported on an inner wall of the block cavity 11, a fixing cap 430 movable along a longitudinal direction of the strap 410 and an insertion unit. For example, the insertion unit includes an anchor rod 450 inserted through the fixing hole 431 of the fixing cap 430 and a support hole 421 of the support piece 420 and coupled to the fixing cap 430 and the support piece 420, and a fastening nut 460 configured to fix the rear panel 100 of the washing machine to the anchor rod 450.

The strap 410 may include a holder member 411 forming a closed loop, support members 412 extending from the opposite sides of the holder member 411 and having their ends rotatably coupled to the support piece 420, and ratchet members 413 formed on inner surfaces of the support members 412 to allow the fixing cap 430 to move in only one direction along the strap. Thus, if a user holds the holder member 411 and pushes the fixing cap 430 along the strap 410 and toward the block wall 10, the fixing cap 430 cannot move backward due to the ratchet members 413. Thus, the fixing cap 430 may be securely pressed against the block wall 10.

The support hole 421, to which the anchor rod 450 is threadedly coupled, is formed at the center of the support piece 420. The fixing hole 431, to which the anchor rod 450 is threadedly coupled, is formed at the center of the fixing cap 430. In a state in which the support piece 420 and the fixing cap 430 are disposed in parallel with each other, the anchor rod 450 may be threadedly coupled to the fixing hole 431 and the support hole 421.

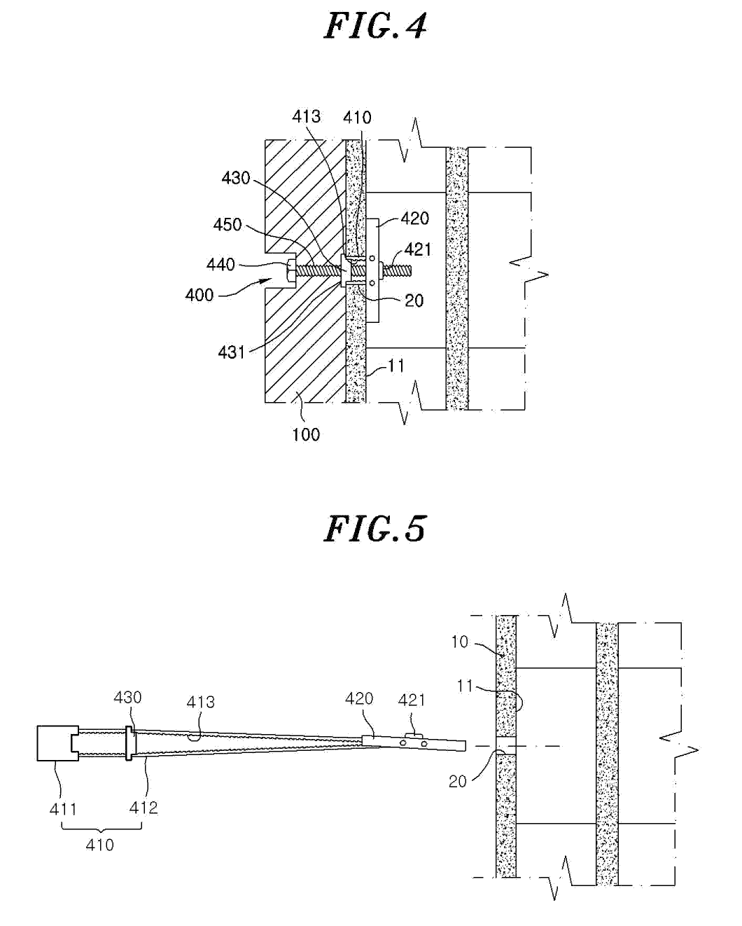

FIG. 4 is an enlarged sectional view illustrating the fastening mechanism between a wall-mounted washing machine and a block wall according to another embodiment of the present disclosure.

As illustrated in FIG. 4, a fastener unit 400 of a wall-mounted washing machine may include a strap 410, a support piece 420, a fixing cap 430 and an insertion unit. For example, the insertion unit is an anchor bolt 440. The strap 410, the support piece 420 and the fixing cap 430 have the similar configuration as described above. Thus, detailed descriptions thereof will be omitted.

The anchor bolt 440 may pass through the rear panel 100 and may be threadedly coupled to the fixing hole 431 and the support hole 421. Thus, the wall-mounted washing machine may be firmly fixed to the block wall 10 without having to use an additional fastening nut 460.

Hereinafter, an installation process of a washing machine on a wall using the fastener unit according to one embodiment of the present disclosure is described with reference to FIGS. 5 to 7.

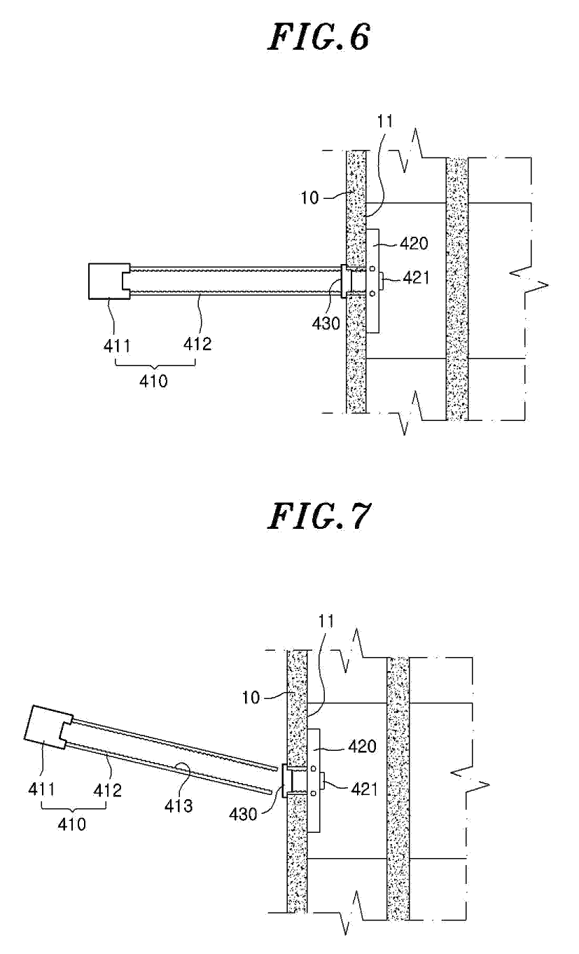

FIG. 5 illustrates the fastening hole 20 formed on the block wall in order to install the wall-mounted washing machine according to one embodiment of the present disclosure on the block wall. FIG. 6 illustrates that the support piece of the fastener unit is inserted into the block cavity and that the fixing cap 430 is pressed against the block wall. FIG. 7 illustrates that one end portion of the strap 410 is removed after the fastening unit is in place.

If the fastening hole 20 is drilled in the block wall 10 as illustrated in FIG. 5, one end portion of the strap 410 is inserted into the fastening hole 20 with the support piece 420 rotated to be orthogonal to the wall. As illustrated in FIG. 6, the support piece 420 is placed within the block cavity 11 of the block wall 10 and is pressed against the inner wall of the block cavity 11 after a user manipulates the strap 410. Then, the fixing cap 430 is pushed along the strap 410 toward the block wall 10 and is pressed against the block wall 10.

As illustrated in FIG. 7, the end portion of the strap 410 (on the rear side of the fixing cap 430) is cut off. In this state, one end of the anchor rod 450 may be threadedly coupled to the fixing hole 431 and the support hole 421. The rear panel 100 may then be attached to the other end of the anchor rod 450.

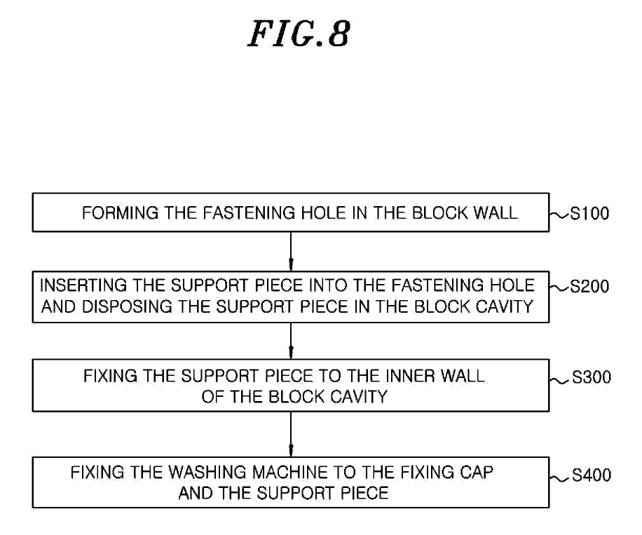

FIG. 8 is a flowchart illustrating an exemplary process of installing the wall-mounted washing machine using a fastening unit according to one embodiment of the present disclosure.

As illustrated in FIG. 8, the method includes: a step (S100) of forming a fastening hole in a block wall; a step (S200) of inserting a support piece into the fastening hole and placing the support piece in a block cavity; a step (S300) of fixing the support piece to an inner wall of the block cavity; and a step (S400) of fixing the washing machine to a fixing cap and the support piece.

At the step S100, a user may drill the wall through to form the fastening hole 20.

At the step S200, the support piece 420 is rotated in one direction and one end of a strap 410 coupled to the support piece 420 is inserted into the fastening hole 20 so that the support piece 420 is positioned within the block cavity 11.

At the step S300, the fixing cap 430 is moved in one direction along the strap 410 and the support piece 420 is affixed to the inner wall of the block cavity 11. For example, the strap 410 is adjusted so that the support piece 420 is pressed against the inner wall of the block cavity 11 and the fixing cap 430 is moved toward one end of the strap 410 and is pressed against the block wall 10. The other end of the strap 410 positioned at the rear side of the fixing cap 430 is then removed.

At the step S400, the fixing cap 430 and the support piece 420 are disposed in parallel with each other, the anchor rod 450 passes through the fixing hole 431 of the fixing cap 430 and the support hole 421 of the support piece 420. The rear panel 100 is placed on the anchor rod 450 and is fixed by a fastening nut 460.

In the case where the anchor bolt 440 is used in place of the anchor rod 450 and the fastening nut 460, the anchor bolt 440 is threadedly coupled to the fixing hole 431 and the support hole 421 through the rear panel 100, thereby tightly affixing the washing machine to the block wall 10.

As described above, according to one embodiment of the present disclosure, a wall-mounted washing machine can be securely mounted on the block wall having a block cavity. The vibration of the washing machine generated in the course of dewatering and rinsing the washing object is restrained from being transferred to the block wall. Embodiments of the present disclosure can advantageously reduce noise generated by vibration and prevent the washing machine from falling from the block wall.

Although exemplary embodiments of the present disclosure are described above with reference to the accompanying drawings, those skilled in the art will understand that the present disclosure may be implemented in various ways without changing the necessary features or the spirit of the present disclosure.

Therefore, it should be understood that the exemplary embodiments described above are not limiting, but only an example in all respects. The scope of the present disclosure is expressed by claims below, not the detailed description, and it should be construed that all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A washing machine comprising:
an housing;
a rear panel coupled to the housing; and
a fastener kit configured to affix the rear panel to a wall, wherein, when the washing machine is mounted on the wall: a first end of the fastener kit is positioned inside a block cavity of the wall through a fastening hole formed on the wall; the fastener kit is operable to support the washing machine against gravity on the wall through contact between the first end and an inner surface of the block cavity; and a second end of the fastener kit is coupled to the rear panel.

2. The washing machine of claim 1 further comprising:
a tub configured to contain washing water; and
a drum rotatably installed in the tub and configured to contain laundry.

3. The washing machine of claim 2, wherein the tub is integrally formed with the rear panel.

4. The washing machine of claim 1, wherein the fastener kit comprises:
a strap operable to be inserted through the fastening hole during a process of mounting the washing machine to an external surface of the wall;
a support piece rotatably coupled to one end of the strap and configured to press against the inner surface of the block cavity when the washing machine is mounted on the wall;
a fixing cap movable along a longitudinal direction of the strap so that the fixing cap is securely pressed against the wall; and
an insertion unit configured to be inserted into the fastening hole so that the insertion unit is combined with the fixing cap and the support piece for securing the coupling between the fixing cap, the support piece and the wall.

5. The washing machine of claim 4, wherein the support piece comprises a support hole at a center thereof, the fixing cap comprises a fixing hole at a center thereof, and
the insertion unit comprises:
an anchor rod for insertion through the fixing hole and the support hole; and
a fastening nut configured to secure the coupling between the rear panel to the anchor rod.

6. The washing machine of claim 4, wherein the support piece comprises a support hole at a center thereof, the fixing cap comprises a fixing hole at a center thereof, and the insertion unit is an anchor bolt inserted through the fixing hole and the support hole so as to fix the rear panel to the wall.

7. The washing machine of claim 4, wherein the strap comprises:
a holder portion forming a closed loop;
support portions extending from opposite sides of the holder portion and having end portions rotatably coupled to the support piece; and
ratchet portions formed on inner surfaces of the support portion.

8. The washing machine of claim 7, wherein the ratchet portions restrict the fixing cap to moving in one direction along the strap.

9. The washing machine of claim 1, wherein the fastener kit further comprises a shock-absorbing member configured to attenuate vibration when it is disposed between an external surface of the wall and the rear panel.

10. A washing machine comprising:
an housing;
a rear panel coupled to the housing;
a fastener kit configured to affix the washing machine through the rear panel to a wall; and
a shock-absorbing member configured to be disposed between the wall and the rear panel to absorb vibration during operation of the washing machine.

11. The washing machine of claim 10, wherein, when the washing machine is mounted on the wall: a first end of the fastener kit is positioned inside a block cavity of the wall through a fastening hole formed on the wall; the fastener kit is operable to support the washing machine against gravity on the wall through contact between the first end and an inner surface of the block cavity; and a second end of the fastener kit coupled to the rear panel.

12. The washing machine of claim 10 further comprising:
a tub configured to contain washing water; and
a drum rotatably installed in the tub, wherein the tub is integrally formed with the rear panel.

13. The washing machine of claim 11, wherein the fastener kit comprises:
a strap operable to be inserted through the fastening hole during an installation process of mounting the washing machine to the wall;
a support piece rotatably coupled to one end of the strap and configured to press against the inner surface of the block cavity when the washing machine is mounted on the wall;
a fixing cap movable along a longitudinal direction of the strap so that the fixing cap is securely pressed against the wall; and
an insertion unit configured to be inserted into the fastening hole so that the insertion unit is combined with the fixing cap and the support piece for securing the coupling between the fixing cap, the support piece and the wall.

14. The washing machine of claim 13, wherein the support piece comprises a support hole at a center thereof, the fixing cap comprises a fixing hole at a center thereof, and the insertion unit comprises:
an anchor rod for being inserted through the fixing hole and the support hole; and
a fastening nut configured to secure the coupling between the rear panel to the anchor rod.

15. The washing machine of claim 13, wherein the strap comprises:
a holder portion forming a closed loop;
support portions extending from opposite sides of the holder portion and having end portions rotatably coupled to the support piece; and
ratchet portions formed on the support portion and configured to restrict the fixing cap to moving in one direction along the strap.

16. A method of installing a washing machine on a wall, the method comprising:
forming a fastening hole in the wall having a block cavity; and
coupling the washing machine to the wall through a fastening kit comprising a strap, a support piece, a fixing cap and an insertion unit, wherein the coupling comprises:
inserting the support piece that is coupled to the strap into the fastening hole and placing the support piece in the block cavity;
moving the fixing cap along the strap and affixing the support piece to an inner wall of the block cavity; and
affixing the washing machine to the fixing cap and the support piece by using the insertion unit configured to be inserted into the fastening hole so that the insertion unit is combined with the fixing cap and the support piece for securing the coupling between the fixing cap, the support piece and the wall.

17. The method of claim 16, wherein the affixing the support piece to the inner wall comprises: adjusting the strap to press the support piece against the inner wall of the block cavity; moving the fixing cap toward one end of the strap; and pressing the fixing cap against an outer surface of the wall.

18. The method of claim 17 further comprising removing one end portion of the strap positioned at a rear side of the fixing cap.

19. The method of claim 16, wherein the insertion unit comprises: an anchor rod and a fastening nut, and the affixing the washing machine to the fixing cap and the support piece comprises: passing the anchor rod through a fixing hole of the fixing cap and a support hole of the support piece, and wherein a rear panel of the washing machine is fitted to the anchor rod and is secured by the fastening nut.

20. The method of claim 19, wherein upon the affixing the washing machine to the fixing cap and the support piece, the fixing cap and the support piece are positioned in parallel with each other.
